SEQUENCE LISTING (38 sequences)

SEQ ID NO: 1 - DNA, 52 bp, Homo sapiens
ggatgccatggacagtaggattccacrgtggggtctacagatgtcatctgag

SEQ ID NO: 2 - DNA, 52 bp, Homo sapiens
cagtgcagatttcaagtggacaattasacatataggtctgatccttgggaaa

SEQ ID NO: 3 - DNA, 52 bp, Homo sapiens
aggtgtgagctaccatgcctggtctcrtgagtcttgttcatcacttacctcc

SEQ ID NO: 4 - DNA, 52 bp, Homo sapiens
cctcagaaaaattaaagcctgctgatwttgaaaattgggtttctcaggtttc

SEQ ID NO: 5 - DNA, 52 bp, Homo sapiens
cccagcggaaggagaattaaatcaaakgaggattcggggacactttctagaa

SEQ ID NO: 6 - DNA, 52 bp, Homo sapiens
atgtatgtatataaaatggataaagcrgcaatggaatttattatacagaaac

SEQ ID NO: 7 - DNA, 52 bp, Homo sapiens
agccaggattggataaagtgtcaagarcaaccctgagcaattgagagtggaa

SEQ ID NO: 8 - DNA, 52 bp, Homo sapiens
tttcatcattgtgtcttcctgtatttktacagcattccacctatttagcaag

SEQ ID NO: 9 - DNA, 52 bp, Homo sapiens
caggaaatgccttcaaaaatcttgttytaaatgtctgcttagatttcagatt

SEQ ID NO: 10 - DNA, 52 bp, Homo sapiens
aaggtggatgtgatgctgaatagtgtycagggaatctgcagccgtaagagaa

SEQ ID NO: 11 - DNA, 52 bp, Homo sapiens
ccagcctgcacatgtaccatctgaatmtaaatgaaaagttgaaattatattt

SEQ ID NO: 12 - DNA, 52 bp, Homo sapiens
gagggaaattacacagccaactcatayttttcagagtgctctggctgcagtg

SEQ ID NO: 13 - DNA, 52 bp, Homo sapiens
atgagcaagagaataagctgtgcagayttcttatttgacctggctttgactt

SEQ ID NO: 14 - DNA, 52 bp, Homo sapiens
aattttatttgaaatgcaaattaaaaragaatctctcacacacacacacaca

SEQ ID NO: 15 - DNA, 52 bp, Homo sapiens
taatgaggcaataccttgtgattaagwgaatggatatgtagctgtattacct

SEQ ID NO: 16 - DNA, 52 bp, Homo sapiens
gccatcttaattactaagtacattctyttatatccatgggtctgtttctgga

SEQ ID NO: 17 - DNA, 52 bp, Homo sapiens
tttttattagaaaactgaaaaaaaaartgccaagtgaacctgcatgctcttt

SEQ ID NO: 18 - DNA, 52 bp, Homo sapiens
ttttagtttaagataactgtacatcawcccagtgcagatttcaagtggacaa

SEQ ID NO: 19 - DNA, 52 bp, Homo sapiens
aggaaatgctcttttacttatcctgayttctaggaatttctgaccatatcac

SEQ ID NO: 20 - DNA, 52 bp, Homo sapiens
ttaggaagtagaaatgtgtagtgaacyggaaattcctacatcattatctgga

SEQ ID NO: 21 - DNA, 52 bp, Homo sapiens
tgacaggggtctgtgtgtcccagttgyatgcacgtttatttccctgttcctt

SEQ ID NO: 22 - DNA, 52 bp, Homo sapiens
tggaaattcctacatcattatctggartctggcctatgaaagagatgtcggc

SEQ ID NO: 23 - DNA, 52 bp, Homo sapiens
acatatgcccatatgcccactgaactygtaaatatcatttccaaaaaagact

SEQ ID NO: 24 - DNA, 52 bp, Homo sapien
tgttcttagatgatttatgaagtgtcmattggtatatgcatatgggtatcta

SEQ ID NO: 25 - DNA, 52 bp, Homo sapiens
gaggactccctagtaagacacaacccwtagatttctgtctgtgtaatcctgg

SEQ ID NO: 26 - DNA, 52 bp, Homo sapiens
tctgtattgcagaataggcactgtcastttgatggtttcctatattctagta

SEQ ID NO: 27 - DNA, 52 bp, Homo sapiens
attttgcagtattttgtctcagaactmaaagatgactatttttgtaaccccc

SEQ ID NO: 28 - DNA, 52 bp, Homo sapiens
actagtcctgttccttttcctgccgcrgttgccatggccgacccaaacaata

SEQ ID NO: 29 - DNA, 52 bp, Homo sapiens
caaagcttgtaagccacttgaaattaygtaaaacctctcaagtcgtttagaa

SEQ ID NO: 30 - DNA, 52 bp, Homo sapiens
ggttgggcttgagacacccaacttaawgggatttaaaggcaggcgagacaca

SEQ ID NO: 31 - DNA, 52 bp, Homo sapiens
tcaaaatgcaacatcgctgtgaaagtrtagacttggagctccagctgaagtc

SEQ ID NO: 32 - DNA, 52 bp, Homo sapiens
tagcattattcataacagctaaaaacyggaatcaacccaaaccaccaaatgc

SEQ ID NO: 33 - DNA, 52 bp, Homo sapiens
agacatggcagtggaaaaaggctttcrcaaacagtttaatttagctaatgga

SEQ ID NO: 34 - DNA, 52 bp, Homo sapiens
tgccataacttccagtatttgagagcrttacttcttcctcatcccacctctt

SEQ ID NO: 35 - DNA, 52 bp, Homo sapiens
gattaatgcagtcactaactacattaygacattccagtcaacaatggactcc

SEQ ID NO: 36 - DNA, 52 bp, Homo sapiens
tcccaacttttccaaccctgctcaatsctgctattaaatacataatagcaac

SEQ ID NO: 37 - DNA, 52 bp, Homo sapiens
gccatgccacttctctgaaactgcttrtatcaagattatcaataaagtctat

SEQ ID NO: 38 - DNA, 52 bp, Homo sapiens
tcaagttaaagcttctatcatcctaartacaccttcagtaaattagaagtat

(19) United States
(12) Patent Application Publication
(10) Pub. No.: US 2012/0077683 A1
(43) Pub. Date: Mar. 29, 2012

(54) KIT AND METHOD FOR PREDICTING CYTARABINE SENSITIVY OF PATIENT HAVING ACUTE MYELOID LEUKEMIA

(75) Inventors: Dae-soon SON, Seoul (KR); Kyu-sang LEE, Ulsan (KR); Sung-ouk JUNG, Hwaseong-si (KR); Sung-min CHI, Hwaseong-si (KR); Kyung-hee PARK, Seoul (KR); Won-seok CHUNG, Suwon-si (KR); Jong-suk CHUNG, Hwaseong-si (KR); Dong-hwan KIM, Seoul (KR); Jhin-gook KIM, Seoul (KR); In-suk SOHN, Seoul (KR); Sin-ho JUNG, Chapel Hill, NC (US)

(73) Assignee: SAMSUNG ELECTRONICS CO., LTD., Suwon-si (KR)

(21) Appl. No.: 13/244,055

(22) Filed: Sep. 23, 2011

(30) Foreign Application Priority Data
Sep. 27, 2010 (KR) 10-2010-0093292

(51) Int. Cl. C40B 20/00; C40B 40/06

(52) U.S. Cl. 506/2; 506/16

(57) ABSTRACT

A kit and method for predicting cytarabine sensitivity of patients having acute myeloid leukemia are disclosed.

### CROSS-REFERENCE TO RELATED APPLICATIONS

This application claims priority to Korean Patent Application No. 10-2010-0093292, filed on Sep. 27, 2010, and all the benefits accruing therefrom under 35 U.S.C. §119, the disclosure of which is incorporated its in their entirety by reference.

### BACKGROUND

1. Field

The present disclosure relates to a kit and method for anticipating cytarabine sensitivity of a patient having acute myeloid leukemia.

2. Description of the Related Art

Leukemia is a disease in which leukocytes abnormally proliferates. Leukemia can be classified into myeloid leukemia or lymphocytic leukemia according to the leukocytes affected and can also be classified into acute leukemia or chronic leukemia according to the rate of development. Clinical outcomes of patients having leukemia vary according to the type of leukemia and characteristics of the affected cells. Lymphocytic leukemia occurs when lymphatic blood cells are affected, and myeloid leukemia occurs when myeloid blood cells are affected. Chronic myeloid leukemia occurs as cells in the maturity period mutate, while acute myeloid leukemia occurs due to dysfunction of myeloid stem cells in differentiation at a relatively early stage of the hematogenous process. Acute myeloid leukemia generally occurs in adults and the aged, with children having acute myeloid leukemia accounting for only about 10 to 15% of all cases. Acute lymphocytic leukemia is the most common leukemia in young children 2 to 10 years old. Chronic myeloid leukemia is frequently diagnosed among people aged more than 60, while chronic lymphocytic leukemia is rare in Korea. It is known that acute myeloid leukemia accounts for about 70% of all acute leukemia.

Symptoms of acute myeloid leukemia are caused by the replacement of normal blood cells (erythrocytes, platelets, and normal leukocytes) with leukemic cells. As the normal bone marrow is filled with leukemic cells, the number of normal blood cells decreases, and accordingly patients having acute myeloid leukemia experience fatigue, dyspnea, bleeding, and frequent infections. Acute myeloid leukemia has been treated with cytarabine since the 1980s. A standard treatment of acute myeloid leukemia, according to the National Comprehensive Cancer Network (NCCN), is administration of cytarabine alone or in combination with other drugs. Although cytarabine has been used as an essential drug for the treatment of acute myeloid leukemia, there are side effects when administered to patients, such as oligocythemia, hypersensitivity, nausea, vomiting, and alopecia. Due to such side effects, secondary anticancer drugs may not be effective. It is known that the administration of cytarabine is not effective on about 20% of patients having acute myeloid leukemia.

Therefore, there is a need to develop a method of predicting cytarabine sensitivity of patients so as to minimize side effects caused by anticancer drugs and to reduce medical expenses.

### SUMMARY

Provided are a kit for predicting cytarabine sensitivity of a patient having acute myeloid leukemia, and a method of predicting cytarabine sensitivity of a patient having acute myeloid leukemia using the kit.

### BRIEF DESCRIPTION OF THE DRAWINGS

These and/or other aspects will become apparent and more readily appreciated from the following description of the embodiments, taken in conjunction with the accompanying drawings of which:

FIG. 1 is a graph plotting the principal component values (PC1, PC2) determined by a principal component analysis of patients having acute myeloid leukemia obtained using genotype data of 329 single nucleotide polymorphism (SNP), wherein solid circles indicate data for patients responsive to cytarabine (CR+), and solid triangles indicate data for patients nonresponsive to cytarabine (CR−); and

FIG. 2 is a graph illustrating leave-one-out cross-validation results for percent accuracy of the predictions of patient sensitivity to cytarabine made using a linear discrimination analysis (LDA) model as a function of the number of SNPs used in the LDA.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present invention.

According to an embodiment of the present invention, there is provided a kit for predicting cytarabine sensitivity of a patient having acute myeloid leukemia. The kit includes polynucleotides having nucleotide sequences of SEQ ID NOS: 1 to 38, or complements thereof, each of which includes a single nucleotide polymorphism (SNP) site at position 27.

The term “single nucleotide polymorphism (SNP)” used herein refers to a single-nucleotide variation between individuals of the same species and is used as known in the art. It is estimated that human SNPs occur at a frequency of 1 in every 1,000 bp.

The term “nucleotide” used herein is a molecule made up of a nitrogenous base, a sugar, and at least one phosphate group, and includes natural nucleotides or nucleotide analogues in which a sugar, base, or phosphate is modified unless otherwise stated (Scheit, Nucleotide Analogs, John Wiley, New York 1980; Uhlman and Peyman, Chemical Reviews, 90:543-584 1990). The term “polynucleotide” used herein refers to a polymer of the nucleotides. Polynucleotides include polydeoxyribonucleotides and polyribonucleotides, as well as polymers of nucleotides including nucleotide analogues. Polynucleotides can be in single- or double-stranded forms. For example, a polynucleotide can be a double- or single-stranded polydeoxyribonucleotide, a double- or single-stranded polyribonucleotide, or a hybrid duplex of a single-stranded polydeoxyribonucleotide and a single-stranded polyribonucleotide

The polynucleotide may include 10 to 52 or 10 to 30 nucleotides containing a SNP site, having a nucleotide sequence selected from the group consisting of nucleotide sequences of SEQ ID NOS: 1 to 38, or complements thereof. In this regard, the SNP site of each of the nucleotide sequences of SEQ ID NOS: 1 to 38, or complements thereof, is position 27.

The polynucleotides having nucleotide sequences of SEQ ID NOS: 1 to 38, each with a polymorphic site at position 27, are reference sequences for identification of the various genomic polymorphic sites (see Table 3) shown herein to be associated with cytarabine sensitivity of patients having acute myeloid leukemia. This association may be identified by administering cytarabine to patients having acute myeloid leukemia, and comparing the nucleotide sequence of genomic DNA obtained from blood samples of patients who are classified as either sensitive (responders) or not sensitive (non-responders) to cytarabine based on which patients went into remission after treatment with cytarabine. The sequence comparison may be performed by immobilizing polynucleotides to detect each of the alleles of a given SNP on a microarray chip, and hybridizing DNA obtained from blood samples of patients who are sensitive or not sensitive to cytarabine with the DNA on the microarray to genotype the patients at the SNP.

Further, if an allelic nucleotide of the SNP is found in double-stranded genomic DNA, it is interpreted that the SNP includes a nucleotide complementary to the nucleotide in the complementary strand of the DNA. For example, in the complementary strand, the nucleotide “T” of the SNP may be “A”.

Leukemia refers to a disease in which leukocytes abnormally proliferate. Leukemias are classified into myeloid leukemia or lymphocytic leukemia according to the leukocytes affected and into acute leukemia or chronic leukemia according to the rate of development. The term “acute myeloid leukemia” used herein refers to a blood cancer in which abnormal white blood cells accumulate in bone marrow and prohibit production of normal leukocytes.

The chemotherapy agent “cytarabine” is cytosine arabinoside, which is a deoxycytidine analogue that acts as a competitive inhibitor of DNA polymerases, and is metabolized into a nucleotide triphosphate having cytotoxicity highly specific for the S phase. In general, cytarabine may be used for chemotherapy for acute myeloid leukemia. However, it is known that the administration of cytarabine is not effective on about 20% of patients having acute myeloid leukemia. According to an embodiment, cytarabine sensitivity of patients having acute myeloid leukemia may be predicted using a kit including the polynucleotides having nucleotide sequences of SEQ ID NOS: 1 to 38, or the complements thereof. For example, the sensitivity of a patient to the administration of cytarabine may be determined by extracting DNA from the patient having acute myeloid leukemia before administering cytarabine to the patient, contacting the DNA with the polynucleotides having nucleotide sequences of SEQ ID NOS: 1 to 38, or a complement thereof, included in the kit under conditions permitting hybridization, and analyzing the results. Analyzing the hybridization results can result in determination of the patient's genotype at the SNPs tested with the polynucleotides, which can be further used to predict the patient's sensitivity to cytarabine. The analysis of the results will be described later.

According to an embodiment, the polynucleotides may be immobilized on a microarray.

The term “microarray” used herein refers to a substrate on which a group of polynucleotides is densely immobilized in a predetermined region. Such a microarray is well known in the art. For example, microarrays are disclosed in U.S. Pat. Nos. 5,445,934 and 5,744,305, the contents of which are entirely incorporated herein by reference.

The polynucleotides having nucleotide sequences of SEQ ID NOS: 1 to 38, or a complement thereof, may be used as hybridizable array elements and may be immobilized onto a substrate. The substrate is a solid or semi-solid support and may include a membrane, a filter, a chip, a slide, a wafer, a fiber, a magnetic nonmagnetic bead, a gel, a tube, a plate, a polymer, a microparticle, and a capillary. The immobilization of the polynucleotide on the substrate may be achieved by noncovalent binding or covalent binding, for example, using UV rays. For example, the polynucleotides may be bound to the surface of glass modified to contain an epoxy compound or an aldehyde group or to a polylysine-coated substrate surface by UV rays. In addition, the polynucleotides may be bound to the substrate by a linker, such as, an ethylene glycol oligomer or a diamine

According to another embodiment of the present invention, there is provided a method of predicting cytarabine sensitivity of a patient having acute myeloid leukemia. The method includes: obtaining a biological sample from a patient having acute myeloid leukemia; identifying the genotype of a SNP in the biological sample with the polynucleotides of the kit; and determining cytarabine sensitivity of the patient based on the patient's genotype data using statistical classification analysis.

According to an embodiment, the statistical classification analysis may be selected from the group consisting of linear discriminant analysis, principal component analysis, quantitative descriptive analysis, logistic regression analysis, support vector machine analysis, and LASSO analysis. These statistical classification analyses are well known in the art, and thus descriptions thereof will be omitted herein.

According to an embodiment, the statistical classification analysis may include determining principal component analysis values PC1 and PC2 based on the identified SNP genotype data for a patient using Equations I and II; and determining cytarabine sensitivity by applying the PC1 and PC2 values to a linear discriminant analysis model with respect to the SNPs that can be genotyped by the polynucleotides contained in the kit.

$$\begin{matrix}PC 1 = {\sum }_{i = 1}^{\# of S N Ps} {c}_{1 i} \cdot S N {P}_{i} & Equation I \\ PC 2 = {\sum }_{i = 1}^{\# of S N Ps} {c}_{2 i} \cdot S N {P}_{i} & Equation II\end{matrix}$$

In Equations I and II, SNPi is a genotype of the i^{th} SNP, is a contribution degree (coefficient) of the i^{th} SNP in the first component obtained in the principal component analysis, and c₂ᵢ is a contribution degree (coefficient) of the i^{th} SNP in the second component obtained in the principal component analysis. In the PCA, the patient genotype at each biallelic SNP is encoded as 0, 1, or 2, depending on the number of minor alleles present in the genotype. For each SNP, the minor (B) allele is the allele in the NCBI dbSNP database designated as the minor allele. PCA was performed using the computer program, R software 2.11 version (Source: R Development Core Team, Regnow).

The method of predicting cytarabine sensitivity of a patient having acute myeloid leukemia will now be described in detail.

The method includes obtaining a biological sample from a patient having acute myeloid leukemia.

The biological sample may be any sample including cells obtained from the patient having acute myeloid leukemia. For example, the biological sample may include blood, lymph, plasma, serum, urine, tissue, cell, organ, bone marrow, saliva, sputum, cerebrospinal fluid, or the like, but is not limited thereto. The biological sample may be, for example, blood, bone marrow, or lymph. The biological sample may be obtained from the patient having acute myeloid leukemia when the type of anti-cancer therapeutic method for the patient is determined, i.e., when administration of cytarabine is determined.

The method includes identifying the genotype of a SNP present in the sample with a polynucleotide contained in the kit.

As described above, the kit includes polynucleotides having nucleotide sequences of SEQ ID NOS: 1 to 38, or complements thereof. The polynucleotides include SNPs associated with cytarabine sensitivity. The genotype of the SNP in the patient may be identified by extracting DNA from the patient having acute myeloid leukemia to whom cytarabine will be administered and hybridizing the DNA with the polynucleotides of the kit.

The hybridization may be performed by controlling hybridization conditions, such as temperature, concentrations of components of the buffer solution, hybridizing and washing times, pH and ionic strength of the buffer solution. The hybridization conditions may vary according to various factors such as the length and GC content of a probe polynucleotide, and a target nucleotide sequence. Hybridization conditions are disclosed by Joseph Sambrook, et al., Molecular Cloning, A Laboratory Manual, Cold Spring Harbor Laboratory Press, Cold Spring Harbor, N.Y. 2001; and M. L. M. Anderson, Nucleic Acid Hybridization, Springer-Verlag New York Inc. N.Y. 1999. For example, among stringent conditions disclosed in the above documents, high stringency conditions include hybridizing at 65° C. using 0.5 M NaHPO₄, 7% sodium dodecyl sulfate (SDS), and 1 mM EDTA, and washing with 0.1× standard sodium citrate (SSC)/0.1% SDS at 68° C. For example, low stringency conditions include washing with 0.2×SSC/0.1% SDS at 42° C.

A signal may be detected to identify whether hybridization occurs. The signal may be detected using various methods according to the detectable label bound to the polynucleotide serving as a probe. The “detectable label” used herein refers to an atom or molecule used to specifically detect a molecule including the label, from among the same type of molecules without the label. For example, the detectable label may include a colored bead, an antigen determinant, enzyme, hybridizable nucleic acid, a chromophore, a fluorescent material, a phosphorescent material, an electrically detectable molecule, a molecule providing modified fluorescence-polarization or modified light-diffusion, or a quantum dot. In addition, the detectable label may be radioactive isotopes such as P³² and S³⁵, a chemiluminescent compound, labeled binding protein, a heavy metal atom, a spectroscopic marker such as a dye, or a magnetic label. The dye may be a quinoline dye, a triarylmethane dye, phthalene, an azo dye, or a cyanine dye, but is not limited thereto. The fluorescent material may be Alexa Fluor 350, Alexa Fluor 430, Alexa Fluor 488, Alexa Fluor 532, Alexa Fluor 546, Alexa Fluor 568, Alexa Fluor 594, Alexa Fluor 633, Alexa Fluor 647, Alexa Fluor 660, Alexa Fluor 680, Cy2, Cy3.18, Cy3.5, Cy3, Cy5.18, Cy5.5, Cy5, Cy7, mcheery, Oregon Green, Oregon Green 488-X, Oregon Green, Oregon Green 488, Oregon Green 500, Oregon Green 514, SYTO 11, SYTO 12, SYTO 13, SYTO 14, SYTO 15, SYTO 16, SYTO 17, SYTO 18, SYTO 20, SYTO 21, SYTO 22, SYTO 23, SYTO 24, SYTO 25, SYTO 40, SYTO 41, SYTO 42, SYTO 43, SYTO 44, SYTO 45, SYTO 59, SYTO 60, SYTO 61, SYTO 62, SYTO 63, SYTO 64, SYTO 80, SYTO 81, SYTO 82, SYTO 83, SYTO 84, SYTO 85, SYTOX Blue, SYTOX Green, SYTOX Orange, SYBR Green YO-PRO-1, YO-PRO-3, YOYO-1, YOYO-3 or thiazole orange, but is not limited thereto. The genotype of a SNP associated with cytarabine sensitivity may be identified by analyzing the presence or absence, or amount, of the hybridization signal generated by the hybridization. In other words, SNP genotype data may be produced by analyzing the signal obtained after hybridizing the DNA contained in the biological sample with the polynucleotides of the kit. The SNP genotype data may be used in the following stages.

Then, the method includes determining principal component analysis values PC1 and PC2 for the patient from the identified SNP genotype data as shown in Equations I and II.

$$\begin{matrix}PC 1 = {\sum }_{i = 1}^{\# of S N Ps} {c}_{1 i} \cdot S N {P}_{i} & Equation I \\ PC 2 = {\sum }_{i = 1}^{\# of S N Ps} {c}_{2 i} \cdot S N {P}_{i} & Equation II\end{matrix}$$

In Equations I and II, SNPi is the genotype of the i^{th} SNP associated significantly with response or nonresponse to cytarabine, c₁ᵢ is a contribution degree (coefficient) of the genotype of the i^{th} SNP in the first component obtained from the principal component analysis, and c₂ᵢ is a contribution degree (coefficient) of the genotype of the i^{th} SNP in the second component obtained from the principal component analysis.

Finally, the method includes determining the sensitivity to cytarabine of a patient by applying the determined PC1 and PC2 values to a linear discriminant analysis model with respect to the SNPs genotyped by the polynucleotides contained in the kit.

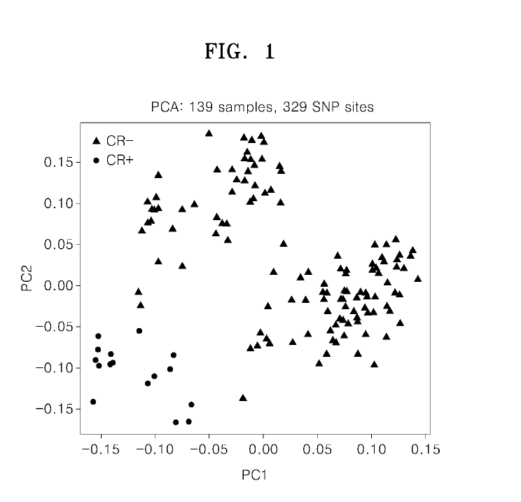

For example, the cytarabine sensitivity of a patient having acute myeloid leukemia may be determined based on the positions of the PC1 and PC2 of the patient in an x-y plane. Linear discriminant analysis is a widely known technique used to obtain a linear discriminant that may divide data on a plane into two groups, and thus the descriptions thereof will be omitted herein. PCA is used for presenting visually that it is possible to differentiate CR+ from CR−. For example, for the data of Example 1 illustrated in FIG. 1, patients who are nonresponsive to cytarabine and patients who are responsive to cytarabine are found in different areas of the PC1-PC2 graph. Thus determination of the PC1 and PC2 values of a patient permit prediction of the patient's sensitivity to cytarabine based on the location of the patient's PC1-PC2. values on the graph. LDA was carried out to calculate the accuracy of differentiating CR+ from CR− by manufacturing a classification model and performing cross-validation.

The present invention will be described in further detail with reference to the following examples. These examples are for illustrative purposes only and are not intended to limit the scope of the invention.

### Example 1

### Determination of SNPs Associated with Cytarabine Sensitivity of Patients Having Acute Myeloid Leukemia

Cytarabine sensitivity of 139 patients who had acute myeloid leukemia and were treated in Samsung Medical Center was identified. That is, cytarabine was administered to the patients according to NCCN guidelines, and the number of leukocytes was subsequently measured in each patient to determine complete remission to determine whether the cytarabine therapy was effective for the patient. The patients were then classified into one group of 121 patients having cytarabine sensitivity (responders) and the other group of 18 patients not having cytarabine sensitivity (nonresponders). In addition, blood of the patients was obtained to extract DNA by using QIAamp DNA Mini and blood Mini kits in order to determine SNPs associated with cytarabine sensitivity of the patients.

Microarray chips to determine SNPs associated with cytarabine sensitivity were prepared according to the following process. First, SNPs obtained from the National Cancer Institute (NCI) Cancer SNP database and the Pharm GKB database (T. E. Klein, et al., “Integrating Genotype and Phenotype Information: An Overview of the PharmGKB Project” (220 k PDF), The Pharmacogenomics Journal (2001) 1, 167-170) were selected for testing. Polynucleotide sequences (probes) to detect each of the alleles of the selected SNPs were immobilized on 14 wafers using a general photolithography method to prepare microarray chips. In the microarray chips, ProcessQC AD=1.62, and CV=13.9% on average.

The probes immobilized onto the microarray chips were hybridized with the extracted DNA samples of all patients at 53° C. for 16 hours to genotype the SNPs in the patients in order to identify which of the tested SNPs were associated with sensitivity to cytarabine. From the tested SNPs, 73,131 SNPs associated with cytarabine sensitivity were selected. A Max Test method was applied to the patient genotypes to identify which of the tested SNPs were associated with sensitivity to cytarabine. The Max Test method will be described as follows.

In the MAX Test method for each SNP, a plurality of genetic models was tested for the significance of association of SNP genotypes of the subjects with cytarabine response or nonresponse to determine the genetic model classification of the SNP by determining the maximum significance among the tested models. Genetic models are models for statistically testing the genetic characteristics of the SNPs, and include a dominant model, a recessive model, and an additive model. In this regard, the significances determined include a classification significance of the SNPs classified into the responder group and the nonresponder group, and each of the significances of the genetic models used to test genetic characteristics of each of the SNPs. The most significant SNPS, determined for any of the 3 genetic models, were selected for prediction modeling. Although tens of thousands or hundreds of thousands of SNPs in the patient population may show allelic variation, some of the variation at SNPs may not be associated with the cytarabine sensitivity. That is, among the SNPs of the subjects, some of the SNPs of the patients may not be associated or may be insignificantly associated with cytarabine sensitivity. Thus, such SNPs may not be considered in the statistical models for predicting response or nonresponse to cytarabine. Accordingly, statistically analyzing genotype data of the SNPs as shown in Table 1 below permits determination of SNPs at which genotypic variation is significantly associated with cytarabine sensitivity and which genotypes show that significant association.

TABLE 1

| SNP 1 | AA | AB | BB | Total |
|---|---|---|---|---|
| Response | x0 | x1 | x2 | x |
| No Response | n0 − x0 | n1 − x1 | n2 − x2 | n − x |
| Total | n0 | n1 | n2 | n |

In Table 1, AA, AB and BB represent the three possible genotypes that can occur for biallelic SNP1 having A and B as the two possible alleles at the site. Response and No Response respectively indicate patient response to cytarabine or that there is no patient response to cytarabine. In more detail, the classification into Response and No Response indicates the classification of the patients treated with cytarabine into a responder group and a nonresponder group. Each of the x0 to x2 indicates the number of each of the AA, AB and BB genotypes in the genotype data of the subjects who are in the responder group (Response). In addition, n0 to n2 respectively indicate the total number of each of the AA, AB and BB genotypes determined in the overall patient group. Accordingly, the number of each of the AA, AB and BB genotypes in the genotype data of the nonresponder group (No Response) is n0-x0, n1-x1 and n2-x2, respectively.

By using the MAX Test method, a group of SNPs with a genotype significantly associated with cytarabine response (CR+) and a group of SNPs with a genotype significantly associated with cytarabine nonresponse (CR−) were selected according to p-values as shown in Table 2 below.

TABLE 2

| p-values | <0.05 | <0.01 | <0.005 | <0.001 |
|---|---|---|---|---|
| Number of SNP | 1,654 | 329 | 192 | 66 |

### Example 2

### Statistical Model for Predicting Cytarabine Sensitivity of Patient having Acute Myeloid Leukemia

A statistical model for predicting cytarabine sensitivity of patients having acute myeloid leukemia was obtained by performing principal component analysis (PCA) on the patient population of Example 1 using the 329 SNPs (p≦0.01) associated with cytarabine response or lack of response from among the SNPs tested in Example 1.

The results are plotted in FIG. 1. In FIG. 1, PC1 and PC2 are the principal component analysis values for each of the patients, obtained using Equations I and II, below, with the genotype data of the 329 SNPs.

$$\begin{matrix}PC 1 = {\sum }_{i = 1}^{\# of S N Ps} {c}_{1 i} \cdot S N {P}_{i} & Equation I \\ PC 2 = {\sum }_{i = 1}^{\# of S N Ps} {c}_{2 i} \cdot S N {P}_{i} & Equation II\end{matrix}$$

In Equations I and II, SNPi is a genotype of the i^{th} SNP, is a contribution degree (coefficient) of the i^{th} SNP in the first component as a result of the principal component analysis, and c₂ᵢ is a contribution degree (coefficient) of the i^{th} SNP in the second component as a result of the principal component analysis.

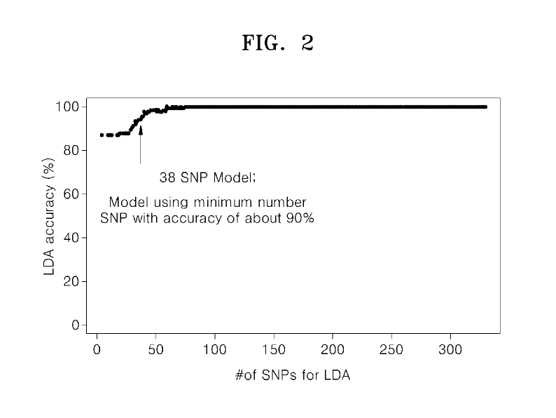

In addition, the accuracy of prediction of response or nonresponse to cytarabine using genotype data for the 329 SNPs was 100% when leave-one-out cross-validation was performed using linear discriminant analysis (FIG. 2). Based on the results, 329 SNPs were sequentially removed from the SNP having the lowest coefficient and cross-validation was performed using the linear discriminant analysis in order to obtain a predictive model for cytarabine sensitivity of the patients having acute myeloid leukemia using a minimum number of SNPs. The accuracy of prediction is shown in FIG. 2. As a result, a statistical model using a minimum number of SNPs, 38, with about 95% accuracy was obtained. NCBI dbSNP Accession Nos. and principal component analysis values of the 38 SNPs in the minimal model are listed in Table 3 below. Reference polynucleotide sequences for each of the 38 SNPs shown in Table 3 are sequentially listed in SEQ ID NOS: 1 to 38.

TABLE 3

| | | | Genetic | A | B |
|---|---|---|---|---|---|
| id | c₁ᵢ | c₂ᵢ | model | allele | allele |
| rs10061370 | −0.305587424 | −3.762119944 | Recessive | A | G |
| rs4470847 | 10.40894129 | 4.337932912 | Recessive | C | G |
| rs4238948 | −3.240465236 | 1.403815759 | Recessive | A | G |
| rs1326596 | 8.539786986 | 4.382126434 | Recessive | A | T |
| rs9474084 | 8.236872463 | 4.468373282 | Recessive | G | T |
| rs682120 | −7.03055848 | 7.747877949 | Recessive | A | G |
| rs1326581 | 10.33066443 | 4.600583889 | Recessive | A | G |
| rs9370062 | 10.33066443 | 4.600583889 | Recessive | G | T |
| rs2397068 | −11.33705801 | −5.494057571 | Dominant | C | T |
| rs3751039 | 2.488978781 | −3.738205617 | Dominant | C | T |
| rs6458788 | 10.33066443 | 4.600583889 | Recessive | A | C |
| rs6458791 | −11.33705801 | −5.494057571 | Dominant | C | T |
| rs9296661 | 10.33066443 | 4.600583889 | Recessive | C | T |
| rs9395726 | 10.33066443 | 4.600583889 | Recessive | A | G |
| rs606803 | −7.202195344 | 7.81004729 | Recessive | A | T |
| rs1326589 | −11.33705801 | −5.494057571 | Dominant | C | T |
| rs11220675 | 4.579482722 | −4.922185221 | Dominant | A | G |
| rs1326584 | −11.16063401 | −5.585414283 | Dominant | A | T |
| rs2380907 | −4.064119529 | −0.317942535 | Additive | C | T |
| rs7949313 | −7.388214529 | 7.772672574 | Recessive | C | T |
| rs3190331 | −3.640668482 | 2.483250799 | Recessive | C | T |
| rs7935457 | −7.388214529 | 7.772672574 | Recessive | A | G |
| rs609996 | 6.38182095 | −8.666146255 | Dominant | C | T |
| rs674682 | 6.38182095 | −8.666146255 | Dominant | A | C |
| rs665097 | 6.38182095 | −8.666146255 | Dominant | A | T |
| rs11220773 | −7.388214529 | 7.772672574 | Recessive | C | G |
| rs652769 | 6.38182095 | −8.666146255 | Dominant | A | C |
| rs3812207 | −3.680804726 | −1.205766693 | Recessive | A | G |
| rs10491059 | 2.51867622 | −2.07449681 | Dominant | C | T |
| rs196009 | 2.005918003 | −2.17406283 | Dominant | A | T |
| rs196008 | −3.012311583 | 1.280589148 | Recessive | A | G |
| rs6469659 | −3.450197434 | −2.507926623 | Dominant | C | T |
| rs9395712 | −7.851597558 | −4.221022388 | Dominant | A | G |
| rs648646 | 6.238011362 | −8.426534483 | Dominant | A | G |
| rs9370043 | 6.231584524 | 1.323341267 | Recessive | C | T |
| rs1690812 | −7.029039213 | 7.485788684 | Recessive | C | G |
| rs9395707 | −7.237978104 | −2.216814948 | Dominant | A | G |
| rs4436551 | −3.346883556 | 3.255169417 | Recessive | A | G |

Table 4 below shows whether cytarabine sensitivity of a patient having acute myeloid leukemia is predictable using the 38 SNP statistical model. The accuracy of prediction with the optimized model using the 38 SNPs may be represented by a percentage of the number of predicted patient responses that are identical to the number of observed patient responses of the total sample. The accuracy of prediction of cytarabine sensitivity is 121−6/121×100=95.04%.

TABLE 4

| | | predicted | | Total |
|---|---|---|---|---|
| Classification | | Cytarabine(−) | Cytarabine(+) | Observed |
| Observed | Cytarabine(−) | 14 | 4 | 18 |
| | Cytarabine(+) | 2 | 119 | 121 |

| | |
|---|---|
| Overall accuracy | 95.04% |

The statistical models used in Examples 1 and 2 to obtain the predictive model for the method are generally used in statistical fields and will be known to one of ordinary skill in the art.

As described above, according to one or more of the above embodiments of the present invention, cytarabine sensitivity may be efficiently predicted using blood samples of patients having acute myeloid leukemia by using the kit and method for predicting cytarabine sensitivity of the patients having acute myeloid leukemia.

The terminology used herein is for the purpose of describing particular embodiments only and is not intended to be limiting of the invention. The terms “a” and “an” do not denote a limitation of quantity, but rather denote the presence of at least one of the referenced item. The terms “comprising”, “having”, “including”, and “containing” are to be construed as open-ended terms (i.e. meaning “including, but not limited to”).

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable.

All methods described herein can be performed in a suitable order unless otherwise indicated herein or otherwise clearly contradicted by context. No language in the specification should be construed as indicating any non-claimed element as essential to the practice of the invention as used herein.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A kit for anticipating cytarabine sensitivity of a patient having acute myeloid leukemia comprising
polynucleotides having nucleotide sequences of SEQ ID NOS: 1 to 38, or the complement thereof,
each of which includes a single nucleotide polymorphism (SNP) at position 27.

2. The kit of claim 1, wherein the polynucleotides are immobilized onto a microarray.

3. A method of predicting cytarabine sensitivity of a patient having acute myeloid leukemia, the method comprising:
obtaining a biological sample from a patient having acute myeloid leukemia;
identifying in the biological sample the patient's genotype at a SNP contained in the kit of claim 1; and
determining the cytarabine sensitivity of the patient using statistical classification analysis of the identified SNP genotype.

4. The method of claim 3, wherein the statistical classification analysis is selected from the group consisting of linear discriminant analysis, principal component analysis, quantitative descriptive analysis, logistic regression analysis, support vector machine analysis, and LASSO analysis.

5. The method of claim 3, wherein the statistical classification analysis comprises:
determining principal component analysis values PC1 and PC2 based on the identified SNP genotype data using Equations I and II and the coefficients of Table 3; and
determining cytarabine sensitivity by applying the PC1 and PC2 values to a linear discriminant analysis model with respect to the SNP,
$$\begin{matrix}PC 1 = {\sum }_{i = 1}^{\# of S N Ps} {c}_{1 i} \cdot S N {P}_{i} & Equation I \\ PC 2 = {\sum }_{i = 1}^{\# of S N Ps} {c}_{2 i} \cdot S N {P}_{i} & Equation II\end{matrix}$$
wherein SNPi is a genotype of the i^{th} SNP, is a contribution degree of the i^{th} SNP in a first component obtained from principal component analysis, c₂ᵢ is a contribution degree of the i^{th} SNP in a second component obtained from principal component analysis.

6. The method of claim 3, wherein the biological sample is blood, bone marrow or lymph.
